(19) United States
(12) Patent Application Publication
(10) Pub. No.: US 2017/0194691 A1
(43) Pub. Date: Jul. 6, 2017

(54) ANTENNA ASSEMBLY MOUNTED IN ELECTRONIC DEVICE HOUSING

(71) Applicant: FOXCONN INTERCONNECT TECHNOLOGY LIMITED, Grand Cayman (KY)

(72) Inventors: LU-CANG QIN, Kunshan (CN); CHUN-CHIEH TSENG, New Taipei (TW); CHI-HSUAN CHANG, New Taipei (TW); HAI-BING LIU, Kunshan (CN); CHANG-CHING LIN, New Taipei (TW); CHAO-TUNG HUANG, New Taipei (TW)

(21) Appl. No.: 15/393,587

(22) Filed: Dec. 29, 2016

(30) Foreign Application Priority Data
Dec. 31, 2015 (CN) 201511013378.6

(51) Int. Cl. H01Q 1/24; H01Q 1/38; H01Q 1/48

(52) U.S. Cl. CPC H01Q 1/24; H01Q 1/48; H01Q 1/38

(57) ABSTRACT

An electronic device including: an inner housing portion and an outer housing portion, the inner housing portion having a cavity, the outer housing portion having an opening; and an antenna assembly including a substrate accommodated in the cavity, a ground element on the substrate, a conductive adhesive portion on the ground element and affixed to the outer housing portion, and a positioning portion on the substrate and received in the opening.

### BACKGROUND OF THE INVENTION

1. Field of the Invention

The present invention relates to an antenna assembly mounted in a cavity formed by an electronic device housing.

2. Description of Related Arts

U.S. Pat. No. 8,269,674, issued on Sep. 18, 2012, discloses an antenna mounted to interior surface of a housing wall adjacent to a media drive opening. The antenna may be implemented using any suitable antenna configuration and conductive antenna elements thereof may be formed from planar traces (patches) on a rigid printed circuit board (antenna substrate). The antenna substrate and associated antenna elements may be mounted to a conductive ground plate which in turn may be grounded to an interior planar surface of a housing portion using conductive adhesive.

U.S. Patent Application Publication No. 2011/0006953, published on Jan. 13, 2011, discloses an electronic device comprising a metal housing structure, an antenna window in the metal housing structure, and a cavity-backed antenna located under the antenna window.

### SUMMARY OF THE INVENTION

An electronic device comprising: a housing including an inner housing portion and an outer housing portion, the inner housing portion having a cavity, the outer housing portion having an opening; and an antenna assembly including a substrate accommodated in the cavity, a ground element on the substrate, a conductive adhesive portion on the ground element and affixed to the outer housing portion, and a positioning portion on the substrate and received in the opening.

### BRIEF DESCRIPTION OF THE DRAWING

FIG. 1 is a perspective view of an antenna assembly in accordance with the present invention;

FIG. 2 is another perspective view of the antenna assembly of FIG. 1;

FIG. 3 is a side view of the antenna assembly;

FIG. 4 is a top view of the antenna assembly;

FIG. 5 is a top perspective view of an electronic device in accordance with the present invention incorporating the antenna assembly;

FIG. 6 is a bottom perspective view of the electronic device of FIG. 5;

FIG. 7 is a top perspective view of the electronic device of FIG. 5 omitting an outer housing portion thereof; and

FIG. 8 is an exploded bottom perspective view of the electronic device of FIG. 5

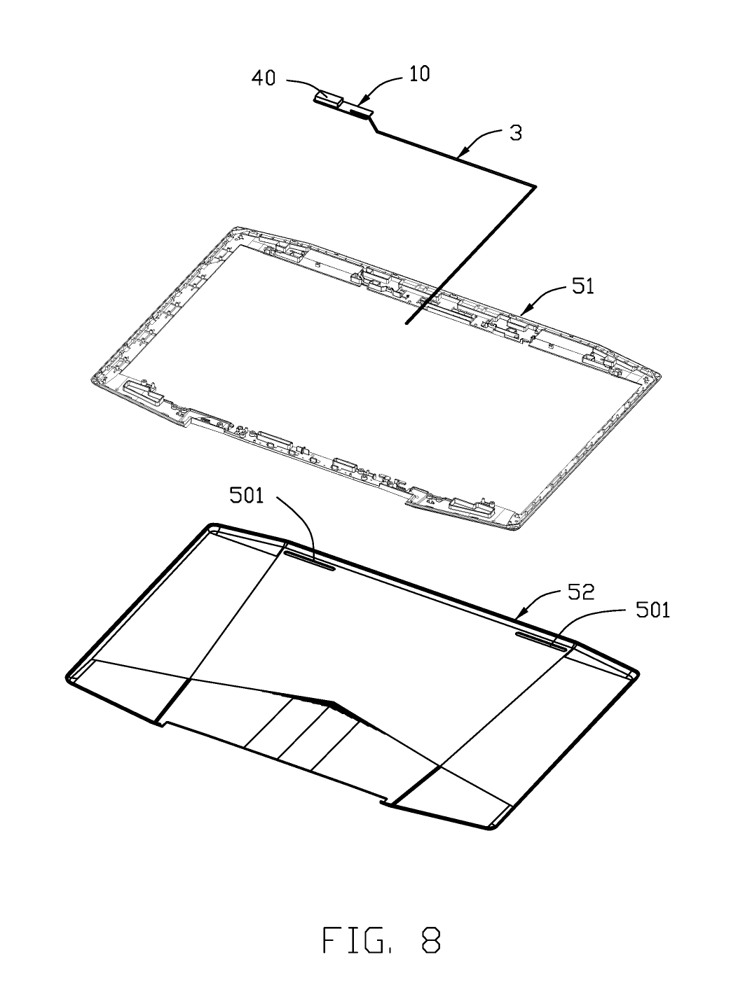

### DETAILED DESCRIPTION OF THE PREFERRED EMBODIMENT

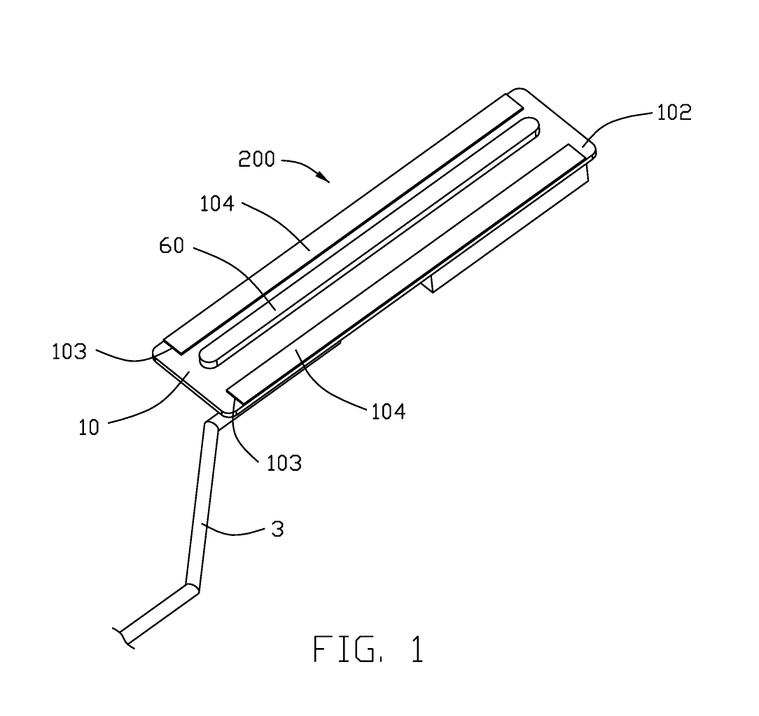

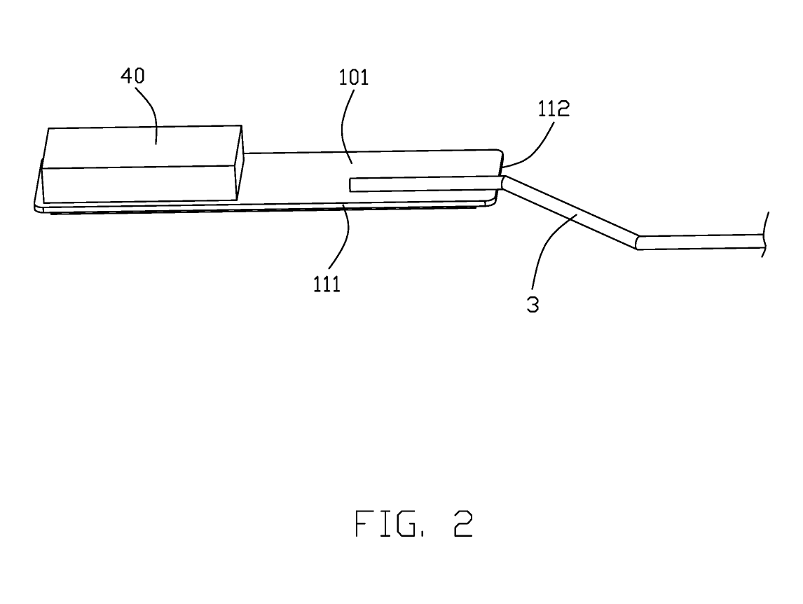

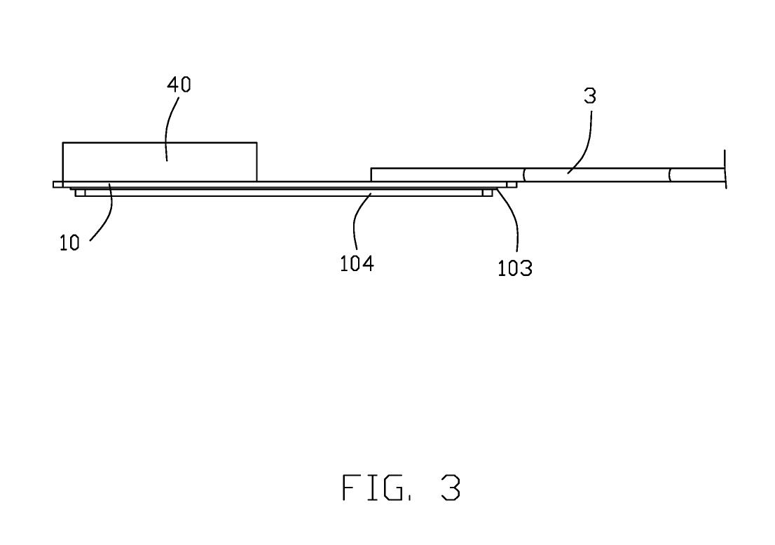

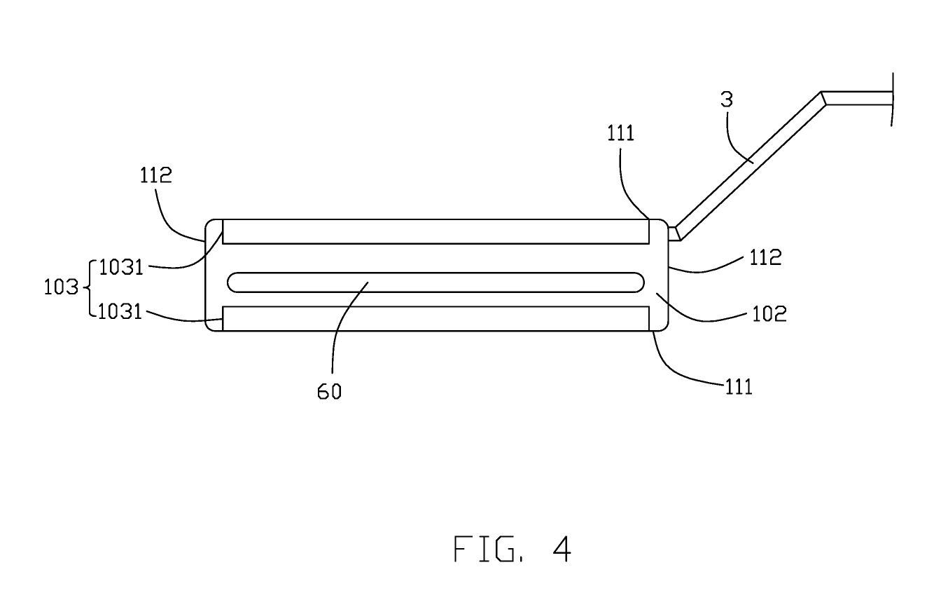

Referring to FIGS. 1 to 4, an antenna assembly 200 comprises a substrate/printed circuit board1 10, a pair of outer circuit pads or ground element portions 103 on the substrate 10 with conductive adhesive portions 104 thereon, and a positioning portion 60 on the substrate 10. The antenna assembly 200 further comprises a feeding cable or member 3. The feeding member 3 being a coaxial cable with an inner conductor and an outer conductor for radiating and grounding respectively, as well know in the arts, may be used to convey radio-frequency signals to and from antenna substrate 10 which implements one or more integrated circuits and associated components well known in this field. Antenna structures that may be used in forming resonating elements for antennas are also well known in this field and thus not illustrated.

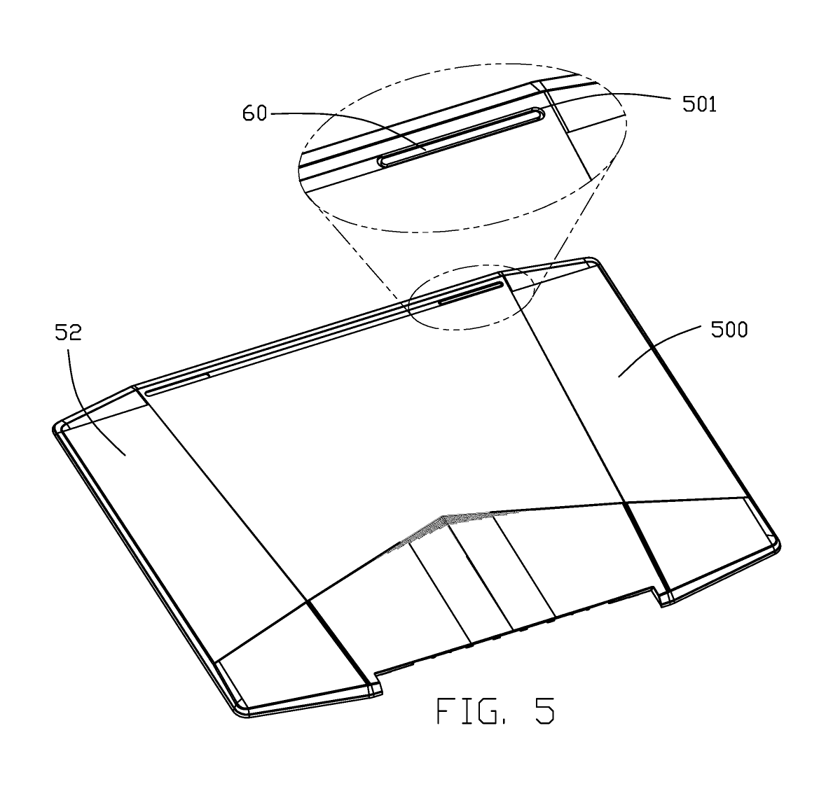

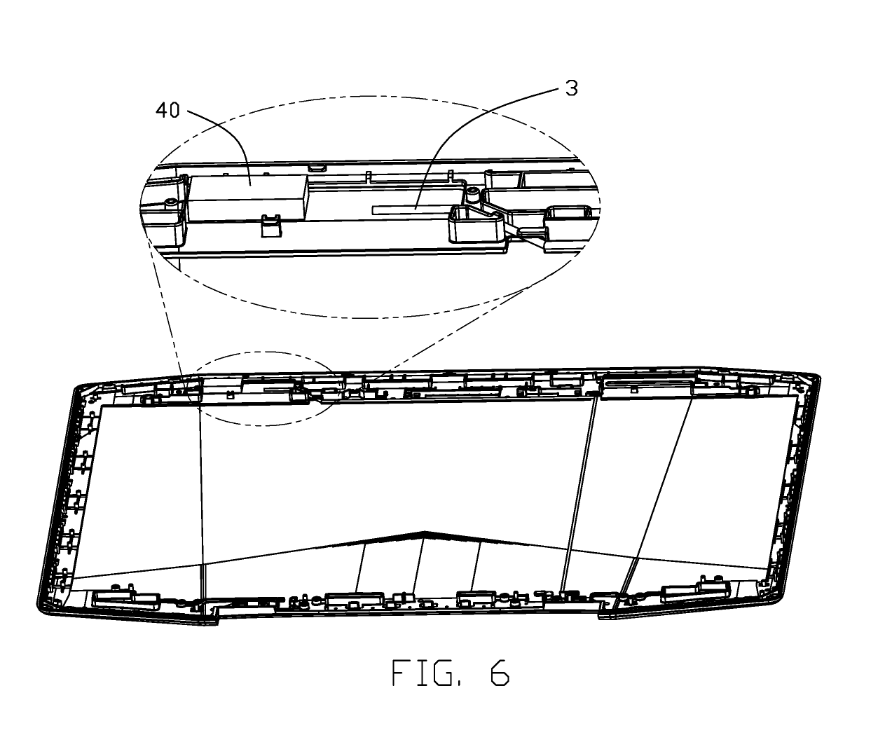

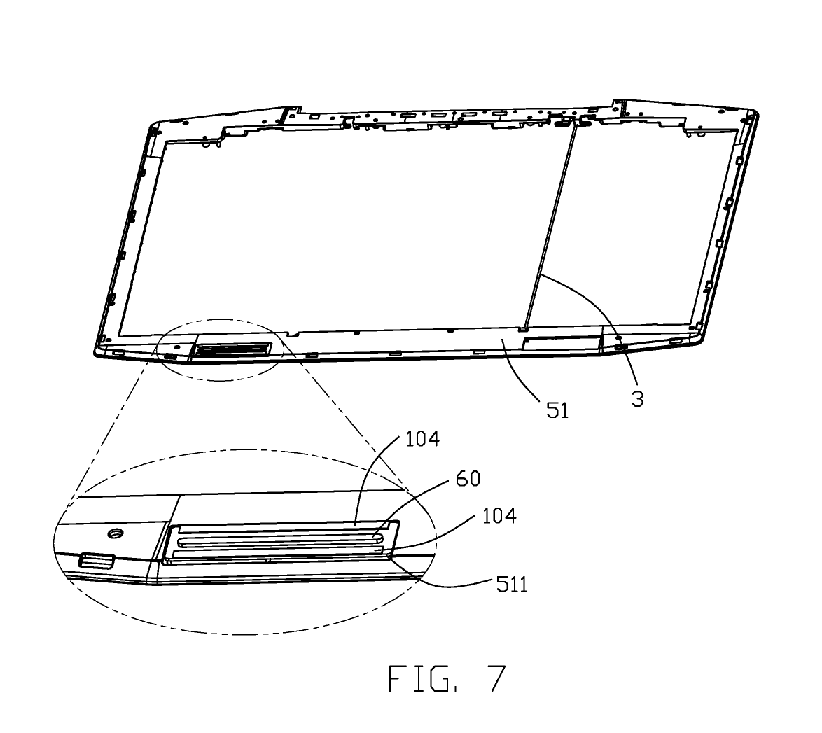

As can be seen in FIGS. 5-7, the conductive adhesive portions 104 affix the substrate 10 directly to a housing 500 of an electronic device.

The substrate 10 has opposite first/inner and second/outer surfaces 101 and 102. The ground element portions 103 are exposed to or provided on the second surface 102. Integrated circuits and associated components, e.g., the radiating element (not shown), implementing an antenna may be provided on the first surface 101 which may be further coated by an insulation as is known in this art. As is also in a known manner, the feeding member 3 such as a coaxial cable is coupled to the first surface 101.

The antenna assembly 200 may further comprise a cushioning member 40 such as foam for resting upon a housing of an electronic device to which the antenna assembly is mounted. The cushioning member 40 may be disposed on the second surface 102 of the substrate 10.

The positioning portion 60 of the antenna assembly 200 is received in an opening 501 of a metallic outer housing portion 52 of the housing 500. The positioning portion 60 is conveniently bonded to the second surface 102 of the substrate 10. In this embodiment, the opening 501 communicates outwardly with the exterior so as to expose the corresponding positioning portion 60 to the exterior.

The pair of ground portions 103 are disposed on two opposite sides of the positioning portion 60. The substrate 10 is elongate and has two opposite longitudinal edges 111 and two opposite lateral edges 112. The pair of ground portions 103 are disposed on the two longitudinal edges 111 of the substrate 10, respectively.

The housing 500 further includes a frame like insulative inner housing portion 51 having a cavity 511. The substrate 10 is protectively accommodated in the cavity 511 with the conductive adhesive portions or layers 104 on the ground portions 103 affixed to an inner wall/interior surface of the outer housing portion 52 and the positioning portion 60 exposed to or received in the opening 501 of the outer housing portion 52. The cushioning member 40 helps to firmly press the conductive adhesive portions 104 against the inner wall of the outer housing portion 52.

What is claimed is:

1. An electronic device comprising:
a housing including an inner housing portion and an outer housing portion, the inner housing portion having a cavity, the outer housing portion having an opening; and
an antenna assembly including a substrate accommodated in the cavity, a ground element on the substrate, a conductive adhesive portion on the ground element and affixed to the outer housing portion, and a positioning portion on the substrate and received in the opening.

2. The electronic device as claimed in claim 1, wherein the ground element comprises a pair of ground portions on two opposite sides of the positioning portion.

3. The electronic device as claimed in claim 2, wherein the substrate is elongate, and the pair of ground portions are disposed on two longitudinal edges of the substrate, respectively.

4. The electronic device as claimed in claim 1, wherein the antenna assembly comprises a feeding member connected to a surface of the substrate distal from the outer housing portion.

5. The electronic device as claimed in claim 1,further comprising a cushioning member on a surface of the substrate distal from the outer housing portion.

6. An electronic device comprising:
a housing having an interior surface and a cavity facing said interior surface,
an antenna assembly including a printed circuit board defining opposite outer surfaces and inner surface, an inner circuit pad functioning as a radiating element and formed on the inner surface, an outer circuit pad functioning as a grounding element and formed on the outer surface, and a feeding cable located upon the inner surface and electrically connecting to the corresponding inner circuit pad and outer circuit pad, said printed circuit board protectively disposed in the cavity with the outer surface intimately facing toward the interior surface of the housing with a conductive adhesive layer tightly sandwiched between the interior surface of the housing and the corresponding outer circuit pad so that the antenna assembly can be assembled in the housing and grounded to the housing.

7. The electronic device as claimed in claim 6, further including said a cushioning member located upon the inner surface through which a force is applied to the printed circuit board for enhancing intimate contacting between the outer surface of the printed circuit board and the interior surface of the housing via said conductive adhesive layer.

8. The electronic device as claimed in claim 6, further including an outwardly protruding positioning portion located upon the outer surface of the printed circuit board and protruding toward the housing, and an opening formed in the housing to receive said positioning portion.

9. The electronic device as claimed in claim 8, wherein said positioning portion is located around a center region of the outer surface, and the outer circuit pad includes two parts respectively located by two sides of the positioning portion.

10. The electronic device as claimed in claim 8, wherein said housing includes a frame like inner housing portion and a plate like outer housing portion, and said opening is formed in the outer housing portion.

11. The electronic device as claimed in claim 10, wherein said opening outwardly communicates with an exterior so as to expose the positioning portion to the exterior.

12. The electronic device as claimed in claim 6, wherein said housing includes a frame like inner housing portion and a plate like outer housing portion assembled together, and said interior surface is located on the outer housing portion while said cavity is formed in the inner housing portion.

13. The electronic device as claimed in claim 11, wherein said inner housing portion is insulative while said outer housing portion is metallic.

14. An electronic device comprising:
a housing having an interior surface with an opening therein,
an antenna assembly including a printed circuit board defining opposite outer surfaces and inner surface, an inner circuit pad functioning as a radiating element and formed on the inner surface, an outer circuit pad functioning as a grounding element and formed on the outer surface, and a feeding cable located upon the inner surface and electrically connecting to the corresponding inner circuit pad and outer circuit pad, an outwardly protruding positioning portion located upon the outer surface of the printed circuit board and received within the opening;
the outer surface of the printed circuit board intimately facing toward the interior surface of the housing with a conductive adhesive layer tightly sandwiched between the interior surface of the housing and the corresponding outer circuit pad so that the antenna assembly can be assembled and grounded to the housing.

15. The electronic device as claimed in claim 14, further including said a cushioning member located upon the inner surface through which a force is applied to the printed circuit board for enhancing intimate contacting between the outer surface of the printed circuit board and the interior surface of the housing via said conductive adhesive layer.

16. The electronic device as claimed in claim 14, wherein said positioning portion is located around a center region of the outer surface, and the outer circuit pad includes two parts respectively located by two sides of the positioning portion.

17. The electronic device as claimed in claim 14, wherein said housing includes a frame like inner housing portion and a plate like outer housing portion assembled together, and said interior surface is located on the outer housing portion while said cavity is formed in the inner housing portion.

18. The electronic device as claimed in claim 17, wherein said opening is formed in the outer housing portion.

19. The electronic device as claimed in claim 18, wherein said opening outwardly communicates with an exterior so as to expose the positioning portion to the exterior.

20. The electronic device as claimed in claim 17, wherein said inner hosing portion is insulative while said outer housing portion is metallic.
